(19) United States
(12) Patent Application Publication
(10) Pub. No.: US 2014/0278318 A1
(43) Pub. Date: Sep. 18, 2014

(54) Natural Resource Reservoir Modeling

(71) Applicant: Schlumberger Technology Corporation, Sugar Land, TX (US)

(72) Inventors: Armin I. Kauerauf, Aachen (DE); Adrian Kleine Aachen, Aachen (DE); Thomas Fuchs, Herzogenrath (DE)

(73) Assignee: Schlumberger Technology Corporation, Sugar Land, TX (US)

(21) Appl. No.: 14/210,540

(22) Filed: Mar. 14, 2014

Related U.S. Application Data
(60) Provisional application No. 61/781,702, filed on Mar. 14, 2013.

(51) Int. Cl. G01V 99/00

(52) U.S. Cl. CPC G01V 99/005
USPC 703/10

(57) ABSTRACT

A method, apparatus, and program product determine an effective trap size for reservoir traps of an oil and gas reservoir. Geological data is analyzed to determine structural spill points. Based on the structural spill points and the geological data reservoir traps are identified. An effective trap size for at least some of the reservoir traps of the reservoir is determined based on the structural spill points and the geological data.

### CROSS-REFERENCE TO RELATED APPLICATIONS

This application claims the benefit of U.S. Provisional Application No. 61/781,702 filed on Mar. 14, 2013 by Kauerauf et al., the entire disclosure of which is incorporated by reference herein.

### BACKGROUND

In gas and oil exploration, potential drilling and production sites (i.e., “prospects”) may be ranked by chance of success for finding gas or oil. This chance may be calculated by convolution of several different geological quantities such as reservoir quality, seal quality, the probability of charging the reservoir from a source rock and the maturity of the source rock. In general, oil and gas reservoirs may include reservoir traps (e.g., oil and gas traps), where such traps generally refer to a subsurface pool of hydrocarbons enclosed in porous or fractured rock formations.

In general, exploration for oil, gas, and other natural resources and extraction thereof may make use of various characteristics of subsurface formations. Therefore, a continuing need exists for improved analysis systems and methods for oil and gas exploration and extraction.

### SUMMARY

Embodiments of the invention disclosed herein provide a method, apparatus, and program product that determine an effective trap size associated with an oil and gas reservoir. A model associated with the reservoir may be generated that includes an effective trap size that corresponds to at least some of the reservoir traps of the reservoir. Consistent with some embodiments of the invention, geological data associated with the reservoir may be received. Structural spill points for the reservoir may be identified based at least one part on the geological data, and reservoir traps of the reservoir may be determined based on the structural spill points. An effective trap size associated with the reservoir may be determined based at least in part the reservoir traps and the structural spill points.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 provides a flowchart that illustrates a sequence of operations that may be performed by the data processing system of FIG. 1 to determine an effective trap size associated with an oil and gas reservoir and generate a visualized model consistent with some embodiments of the invention.

FIG. 6 provides a flowchart that illustrates a sequence of operations that may be performed by the data processing system of FIG. 1 to evaluate a reservoir based on economic values and/or determine a chance of success associated with the reservoir consistent with some embodiments of the invention.

FIG. 7 provides a flowchart that illustrates a sequence of operations that may be performed by the data processing system of FIG. 1 to determine effective traps and an effective trap size for a reservoir consistent with some embodiments of the invention.

FIG. 8 provides a depth view of an example oil and gas reservoir.

FIG. 9 provides a depth view of an example oil and gas reservoir.

FIG. 10 provides a depth view of an example oil and gas reservoir.

FIG. 11 provides an example map of geological features mapped to a chance of success scale for an oil and gas reservoir.

FIG. 12 provides a map view of an example oil and gas reservoir.

FIG. 13 provides an example graphical user interface that may be output to a display of a computing system consistent with some embodiments of the invention.

### DETAILED DESCRIPTION

The herein-in described embodiments of the invention provide a method, apparatus, and program product that may determine an effective trap size associated with an oil and gas reservoir. In general, the effective trap size may be included in a model of the oil and gas reservoir. Consistent with some embodiments of the invention, the effective trap size may be used in determining a probability of success associated with the oil and gas reservoir for extraction of hydrocarbon based compounds, determining an economic value associated with the oil and gas reservoir, ranking the oil and gas reservoir relative to other oil and gas reservoirs, and/or other such processes that may be performed when analyzing oil and gas reservoirs for prospecting.

In general, an oil and gas reservoir may include one or more reservoir traps (also referred to as structural traps), where a reservoir trap generally corresponds to a subsurface pool of hydrocarbons enclosed in porous or fractured rock formations. A reservoir trap may form as a result of changes in a subsurface, where such changes may block the upward migration of hydrocarbons, which may lead to the formation of an oil and gas reservoir. A structural spill point generally corresponds to a lowest point of a reservoir trap that may retain hydrocarbons. Once a reservoir trap is filled to an associated spill point, further storage or retention of hydrocarbons may not occur for lack of reservoir space within the reservoir trap. In this case, the hydrocarbons may spill or leak out and migrate to another reservoir trap. In some reservoirs, some reservoir traps may be proximate one another and/or have a common spill point therebetween (i.e., related reservoir traps), such that hydrocarbons spilling from a first reservoir trap by way of a common spill point may be trapped in a second reservoir trap that is associated with the common spill point.

In some embodiments of the invention, related traps may be merged to form an effective trap that is representative of the related reservoir traps, but reflects a different estimation of oil and gas volume retained in the related reservoir traps. An effective trap size based on the effective trap may be used in oil and gas subsurface modeling and prospecting. An effective trap size may be determined for the effective trap such that the effective trap size corresponds to the overall size of the related reservoir traps that have been merged. In some embodiments, the effective trap size may be larger than the sum of individual trap sizes of the related reservoir traps. In general, the merging of related reservoir traps and the determination of the effective trap size may be based at least in part on the structural spill points and rules associated with the spilling and back spilling of hydrocarbons for proximate structures (e.g., related reservoir traps) having a common spill point. In these embodiments, structural spill points may be analyzed to determine an overall spill point for the related reservoir traps based on a depth associated with each structural spill point. Based on the overall spill point, the related reservoir traps may be merged, and the effective trap size may be determined based at least in part on the overall spill point. In some embodiments of the invention, the effective trap size may correspond to a volume, where such volume may be used to estimate a volume of hydrocarbons trapped in the one or more related reservoir traps corresponding to the effective trap.

Embodiments of the invention may utilize the effective trap size associated with a reservoir for quantifying possible oil and gas resources for a reservoir, estimating oil and gas resources prior to drilling, modeling the oil and gas reservoir, and/or other such oil and gas exploration related computer implemented processes. Other variations and modifications will be apparent to one of ordinary skill in the art.

### Hardware and Software Environment

Turning now to the drawings, wherein like numbers denote like parts throughout the several views, FIG. 1 illustrates an example data processing system 10 in which the various technologies and techniques described herein may be implemented. System 10 is illustrated as including one or more computers 11, e.g., client computers, each including a central processing unit 12 including at least one hardware-based microprocessor coupled to a memory 14, which may represent the random access memory (RAM) devices comprising the main storage of a computer 11, as well as any supplemental levels of memory, e.g., cache memories, non-volatile or backup memories (e.g., programmable or flash memories), read-only memories, etc. In addition, memory 14 may be considered to include memory storage physically located elsewhere in a computer 11, e.g., any cache memory in a microprocessor, as well as any storage capacity used as a virtual memory, e.g., as stored on a mass storage device 16 or on another computer coupled to a computer 11.

Each computer 11 also generally receives a number of inputs and outputs for communicating information externally. For interface with a user or operator, a computer 11 generally includes a user interface 18 incorporating one or more user input devices, e.g., a keyboard, a pointing device, a display, a printer, etc. Otherwise, user input may be received, e.g., over a network interface 20 coupled to a network 22, from one or more servers 24. A computer 11 also may be in communication with one or more mass storage devices 16, which may be, for example, internal hard disk storage devices, external hard disk storage devices, storage area network devices, etc.

A computer 11 generally operates under the control of an operating system 26 and executes or otherwise relies upon various computer software applications 27, components, programs, objects, modules, data structures, etc. For example, a reservoir modeling application 28 may be used to determine an effective trap size for an oil and gas reservoir and/or and model various characteristics of the reservoir. The reservoir modeling application 28 may interface with a collection platform 32, which may include a database 34 within which may be stored/collected reservoir data 36, including geological data and/or other petrotechnical data 38. The reservoir data 36/geological data may include acoustic data collected for a reservoir. For example, the geological data may include depth maps of a top and bottom seal of a reservoir, porosity maps of a reservoir, net-to-gross ratio maps, locations and depth of spill points, fault location information (e.g., maps, lines, triangulated surface maps, fault properties), and/or other such types of subsurface information collected from a prospecting site having a possible oil and gas reservoir. The collection platform 32 and/or database 34 may be implemented using multiple servers 24 in some implementations, and it will be appreciated that each server 24 may incorporate processors, memory, and other hardware components similar to a client computer 11. In addition, in some implementations collection platform 32 may be implemented within a database.

As a non-limiting example, modeling application 28 and/or the collection platform 32 may be compatible with and/or implemented as a component of computer software tools related to oil and gas prospecting, petroleum systems modeling, oil and gas exploration, oil and gas reservoir modeling, subsurface/geological properties modeling and analysis, basin modeling and analysis, oil and gas exploration and production economic analysis, and/or other such types of software environments, platforms, components, packages, suites, and/or tools. In one non-limiting embodiment, for example, the modeling application 28 and/or the collection platform 32 may be compatible with and/or implemented as a component of PETROMOD petroleum systems modeling software platform and environment, GEOX exploration risk and resource assessment software platform and environment, and PETREL exploration geology software platform and environment, which are available from Schlumberger Ltd. and its affiliates. It will be appreciated, however, that the techniques discussed herein may be utilized in connection with other applications/platforms, so the invention is not limited to the particular software platforms and environments discussed herein. Moreover, those skilled in the art will appreciate that various operations and/or functionality of the modeling application 28 and/or the collection platform 32 may be implemented on one or more client computers 11 and/or servers 24.

In general, the routines executed to implement the embodiments disclosed herein, whether implemented as part of an operating system or a specific application, component, program, object, module or sequence of instructions/operations, or even a subset thereof, will be referred to herein as “computer program code,” or simply “program code.” Program code generally comprises one or more instructions that are resident at various times in various memory and storage devices in a computer, and that, when read and executed by one or more processors in a computer, cause that computer to execute steps or elements embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the example environment illustrated in FIG. 1 is not intended to limit the invention. Indeed, those skilled in the art will recognize that other alternative hardware and/or software environments may be used without departing from the scope of the invention.

### Oilfield Operations

FIGS. 2a-2d illustrate simplified, schematic views of an oilfield 100 having subterranean formation 102 containing reservoir 104 therein in accordance with implementations of various technologies and techniques described herein. FIG. 2a illustrates a survey operation being performed by a survey tool, such as seismic truck 106.1, to measure properties of the subterranean formation. The survey operation is a seismic survey operation for producing sound vibrations. In FIG. 2a, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2b illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan generally sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2c illustrates a wireline operation being performed by wireline tool 106.3 suspended by rig 128 and into wellbore 136 of FIG. 2b. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein. In general, wireline tool 106.3 may thereby collect acoustic data and/or image data for a subsurface volume associated with a wellbore.

Wireline tool 106.3 may be operatively connected to, for example, geophones 118 and a computer 122.1 of a seismic truck 106.1 of FIG. 2a. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2d illustrates a production operation being performed by production tool 106.4 deployed from a production unit or christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2b-2d illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2a-2d are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2a-2d, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Reservoir Effective Trap Modeling

In general, embodiments of the invention may determine an effective trap that corresponds to related reservoir traps of an oil and gas reservoir. An effective trap size may be determined based on the effective trap that generally corresponds to a hydrocarbon volume that may be trapped in the related reservoir traps. Accordingly, the effective trap size may be used to estimate hydrocarbon volume, economic values, and/or other such characteristics of the reservoir for oil and gas prospecting.

Turning now to FIG. 5, this figure provides flowchart 400 that illustrates a sequence of operations that may be performed by a computing system consistent with embodiments of the invention to determine an effective trap size associated with a reservoir. As shown, geological data may be received by the computing system (block 402). The geological data may be analyzed to identify the reservoir (block 403). In general, the reservoir (also referred to as a reservoir layer) may be defined by an upper and lower seal (also referred to as a sealing region) that comprises impermeable structures which impede the escape of hydrocarbons from the reservoir. The geological data may be analyzed to identify structural spill points associated with the reservoir (block 404). Based on the structural spill points, reservoir traps (also referred to as structural traps) may be identified (block 406). Based on the structural spill points and the reservoir traps, one or more effective traps may be determined (block 408), where each effective trap is generally representative of two or more related reservoir traps. Based on the structural spill points and the effective traps, an effective size may be determined for each effective trap (block 410). In some embodiments, a reservoir model that includes an indicator for each effective trap, each identified structural spill point, and/or each effective trap size may be generated (block 412). In these embodiments, a visualization of the model may be generated (block 414) for output to a display of a computing system for review by a user.

FIG. 6 provides a flowchart 450 that illustrates a sequence of operations that may be performed by a computing system consistent with embodiments of the invention to analyze a reservoir based at least in part on an effective trap size (block 452). Based on the effective trap size embodiments of the invention may determine a hydrocarbon based compound value for the reservoir (block 454). In general, hydrocarbon based compounds includes oil and resources. Therefore, embodiments of the invention may estimate a value of oil and gas of the reservoir based at least in part on the effective trap size, where such value may refer to a volume or other such measurement used in oil and gas exploration. Based on the effective trap size and the hydrocarbon based compound value, the computing system determines an economic value for the reservoir (block 456). For example, a monetary value may be determined for the reservoir. In some embodiments, the reservoir may be ranked (block 458) relative to a plurality of other reservoirs for which an economic value has been determined based at least in part on an effective trap size. Furthermore, in some embodiments associated with oil and gas prospecting and exploration, embodiments of the invention may determine a chance of success associated with the reservoir (block 460) based at least in part on the effective trap size. In general, the chance of success may be used in various prospecting analysis and modeling to determine whether to develop an oil field associated with the reservoir.

FIG. 7 provides a flowchart that illustrates a sequence of operations that may be performed by a computing system consistent with some embodiments of the invention to determine an effective trap size for related reservoir traps based on identified structural spill points and identified reservoir traps (block 502) for an oil and gas reservoir. A seal for the reservoir may be identified based on the geological data (block 504). In general, a seal (also referred to as cap rock) corresponds to an impermeable structure that forms the upper limit of the oil and gas reservoir by impeding the escape of hydrocarbons from reservoir rock. A depth may be determined for each structural spill point (block 506). Based on the identified structural spill points and the reservoir traps, common structural spill points may be determined (block 508). As discussed, two or more reservoir traps may share and/or be proximate to a spill point (referred to as a common spill point), such that oil and gas may spill between the two or more reservoir traps via the common spill point.

Based on the determined common structural spill points, related reservoir traps may be determined (block 510), where related reservoir traps generally refers to reservoir traps that share and/or are proximate a structural spill point. The related reservoir traps are merged to form an effective trap that corresponds to the related reservoir traps (block 512). An overall spill point is determined for the effective trap (block 514), where the overall spill point is determined based at least in part on a depth of the structural spill points associated with the related reservoir traps. In general, the overall spill point corresponds to the structural spill point at which hydrocarbons will spill from the related reservoir traps. A contact area may be determined for the effective trap (block 516). The contact area generally refers to a defining limit between water and hydrocarbons in the reservoir. In general, hydrocarbons are less dense that water in a reservoir such that the hydrocarbons are above water in the reservoir, and therefore, the contact area defines a lower limit of hydrocarbons in the reservoir. Based on the overall spill point, the seal, and the contact area, an effective trap size may be determined for the related reservoir traps of the effective trap (block 518). In general, the effective trap size may be a volume that is defined by the upper limit of the seal and the lower limit of the overall spill point.

FIG. 8 provides a functional depth view of the characteristics an example reservoir 600. As shown, a seal 602 (also referred to as a sealing region) may form an upper limit, and a contact area 604 (illustrated as a dashed line) may represent a lower limit for hydrocarbons in the reservoir 600. In this example, the reservoir 600 includes a first reservoir trap 608 and a second reservoir trap 610 that have a common spill point 612 therebetween. In this example reservoir 600, an overall spill point 614 corresponds to the structural spill point at which hydrocarbons will escape the two reservoir traps 608, 610. Similarly, FIG. 9 provides a depth view of the characteristics of an example reservoir 650 having a seal 652 and a contact area 654 defining a volume that may store hydrocarbons. A first reservoir trap 656 and a second reservoir trap 658 share a common spill point 660 (i.e., the first and second reservoir traps are related reservoir traps). An overall spill point 662 corresponds to the structural spill point at which hydrocarbons will escape the two reservoir traps 658, 660. FIG. 10 provides a depth view of the characteristics of an example reservoir 700 that includes a seal 702 and a contact area 704 that represents an upper and lower limit for a volume of hydrocarbons that may be stored by the reservoir 700. The reservoir 700 includes a first reservoir trap 706 and a second reservoir trap 708 (also referred to as a microstructure) that share a common spill point 710 such that the first reservoir trap 706 and the second reservoir trap 708 are related. In this example, the overall spill point 712 corresponds to the structural spill point at which hydrocarbons will spill out of the related reservoir traps 706, 708.

Therefore, in the examples provided in FIGS. 8-10, according to embodiments of the invention, the related reservoirs may be merged into an effective trap, and an effective trap size may be determined. As can been seen in the examples, in some reservoirs, an effective trap size may more accurately estimate a volume of hydrocarbons held by the reservoir as compared to an estimation of the volume of hydrocarbons based upon a size of the reservoir traps individually. Therefore, consistent with some embodiments of the invention, a determination of hydrocarbon volume stored in a reservoir may be based on an effective trap size.

Based at least in part on the determined hydrocarbon volume, embodiments of the invention may evaluate a reservoir for a chance of success for finding and extracting oil and gas resources from the reservoir. Furthermore, the reservoir may be ranked relative to other reservoirs based on the chance of success and/or other economic values that may be determined based on the effective trap size. FIG. 11 provides an example chart 600 that provides maps grouped with geological features that are mapped to a corresponding image on a chance of success (COS) with a scale from zero to one that corresponds to a chance of a basin having oil and gas resources that may be extracted.

FIG. 12 provides a map view of a reservoir 800 similar to the reservoir shown in FIG. 9 that illustrates a flow of hydrocarbons (e.g., oil) continuously charging the reservoir. A lower reservoir trap (a first reservoir trap) in the map is filled with oil (illustrations 802-806) along the illustrated flow paths. After the lower reservoir trap is fully filled (also referred to as charged) (illustration 804), hydrocarbons spill along a spill path to an upper reservoir trap (a second reservoir trap). Filling continues until back spill occurs to the lower reservoir trap (illustration 806). The two reservoir traps merge to one (illustration 808). Filling continues until the merged effective trap (that is representative of the merging of the upper and lower reservoir traps) is full (illustration 810). In this example, the effective capacity (i.e., the effective trap size) of the merged trap (illustration 810) is larger than the two separated reservoir traps (illustration 806). Once the effective trap is full, oil spills into oil drainage areas (illustration 812), which may be used to identify structural spill points for the reservoir.

FIG. 13 provides an example graphical user interface 850 that may be output to a display of a computing system consistent with some embodiments of the invention. In this example, a user may select one or more geological features/characteristics 852 of a prospect (e.g., a basin or reservoir) to analyze and model to determine a chance of success for oil and gas exploration for the basin and/or reservoir. In the example, charge features, reservoir features, seal features, trap features, and/or preservation features of the basin and/or reservoir may be utilized in determining a chance of success for oil and gas exploration.

While some embodiments of the invention have been described with respect to an effective trap size for a reservoir, the invention is not so limited. As should be appreciated, some oil and gas reservoirs may comprise a plurality of reservoir traps, which may or may not be related. As such, embodiments of the invention may determine one or more effective traps for the reservoir for one or more groups of related reservoir traps. Accordingly, an effective trap size of a reservoir may be based on one or more effective trap sizes determined for one or more effective trap sizes for related reservoir traps.

Accordingly, some embodiments may include one or more of a method, computing device, computer-readable medium, and system for determining effective trap size for prospect risking. Some embodiments comprise a chance of successful exploration determination (i.e., chance of success) that may be determined with one or more computer implemented methods based at least in part on effective trap size. The determination of a chance of success may be referred to as “play to prospect risk analysis”, “play chance mapping”, “play chance assessment” or “exploration geology analysis”. Additional details regarding reservoirs, reservoir traps, and various characteristics thereof may be found, for example, in T. Hantschel & A. I. Kauerauf: Fundamentals of Basin and Petroleum Systems Modeling, Springer 2009, Sec. 6.5, which is incorporated by reference herein.

As discussed, some embodiments may include the calculation of structural spill points and a merger of reservoir traps according to rules based on spilling and back spilling from nearby structures which share the same spill point. In such situations a merging of structures (i.e., reservoir traps) and calculation/re-calculation of oil and/or gas storage volume may be involved for a more accurate estimation of effective trap sizes. An effective trap size can be taken into account in a convolution procedure of the risk assessment, which may allow for an improved quantification of the possible petroleum (i.e., hydrocarbons, oil and gas resources) in place and thus for an improved chance of successful exploration as compared to quantifications based on individual analysis of reservoir traps. Hence, a chance of finding oil and gas in exploration can be estimated for prospects before drilling based on the effective trap size. The chance of success may be calculated in a risking procedure based on some geological features such as seal and reservoir quality, petroleum generation potential, effective trap size, etc.

In general, trap sizes may be calculated by searching of structural spill points, i.e. of potentially completely filled structures. Hydrocarbons (e.g., petroleum) are generally lighter than surrounding water in a reservoir. A contact area between water and petroleum may generally be considered to be a flat, horizontal meniscus and thus trap size can be calculated by numerical evaluation of the volume between the seal above the flat meniscus within a reservoir (e.g., the shaded areas of the reservoir traps 608, 610 of FIG. 8). When, however, reservoir traps share a structural spill point (i.e., related reservoir traps), overcharging of these two structures (i.e., merging) with oil can lead to one accumulation covering both traps (see e.g., FIG. 9) (a merged or effective trap). In this case, the depth of oil and gas may be given by the overall spill point (e.g., spill point 662 of FIG. 9). The volume (i.e., effective size) of the merged reservoir traps may then be based on the overall spill point, as compared to the individual spill points of the related reservoir traps. Hence, in the example shown in FIG. 9, the effective trap size may be larger than the sum of the separate reservoir traps (the example shown in FIG. 8).

Determining effective trap size may comprise calculating spill points and corresponding depths, searching spill points which are common to at least two reservoir traps, defining effective traps, and calculating an effective trap size based on a volume between a reservoir seal and a depth of an overall spill point. Generally, searching spill points and merging reservoir traps may be performed with a petroleum drainage area subdivision of a top seal reservoir map (see e.g., FIG. 12). Consistent with embodiments of the invention, basin modeling, reservoir modeling, chance of success assessments, and/or other such oil and gas prospecting procedures may be based at least in part on effective trap sizes associated with one or more reservoirs.

It will be appreciated that determination of trap sizes or volumes of effective traps based upon overall spill points would be well within the abilities of one of ordinary skill in the art having the benefit of the instant disclosure, as would implementation of the herein-described techniques in a computer system.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While the present invention has been illustrated by a description of various embodiments and while these embodiments have been described in considerable detail, it is not the intention of the Applicant to restrict or in any way limit the scope of the appended claims to such detail. For example, the operations represented by blocks of the flowcharts included herein may be reorganized, performed concurrently, and/or sequentially in any order. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method for modeling an oil and gas reservoir, the method comprising:
receiving geological data associated with a reservoir;
identifying, with at least one processor, a plurality of structural spill points for the reservoir based at least in part on the geological data;
identifying a plurality of reservoir traps for the reservoir based at least in part on at least a portion of the identified structural spill points; and
determining an effective trap size associated with the reservoir based at least in part on at least a portion of the identified reservoir traps and structural spill points.

2. The method of claim 1, further comprising:
determining an economic value of the reservoir based at least in part on the determined effective trap size.

3. The method of claim 2, further comprising:
ranking the reservoir relative to a plurality of other reservoirs based at least in part on the determined economic value.

4. The method of claim 1, wherein determining the effective trap size associated with the reservoir comprises:
merging at least two reservoir traps based at least in part on at least a portion of the identified structural spill points; and
determining an effective trap size for the at least two merged reservoir traps,
wherein the effective trap size associated with the reservoir is based at least in part on the effective trap size for the at least two merged reservoir traps.

5. The method of claim 1, wherein determining the effective trap size for the reservoir comprises:
determining a contact area between water and hydrocarbon based compounds in at least a portion of the identified reservoir traps from the geological data;
determining a seal associated with the reservoir from the geological data,
wherein the effective trap size is based at least in part on the contact area in each of the at least a portion of the identified reservoir traps, the seal associated with the reservoir, and at least a portion of the identified structural spill points.

6. The method of claim 1, further comprising:
determining a depth for a first structural spill point among the identified structural spill points, wherein the effective trap size is determined based at least in part on the depth for the first structural spill point.

7. The method of claim 1, wherein determining the effective trap size associated with the reservoir comprises:
identifying at least two related reservoir traps from among the identified reservoir traps;
identifying an overall spill point for the at least two related reservoir traps based at least in part on a depth associated with at least one identified structural spill point corresponding to at least one of the at least two related reservoir traps; and
determining an effective trap size for the at least two related reservoir traps based at least in part on the depth of the identified overall spill point,
wherein the effective trap size associated with the reservoir is based at least in part on the effective trap size for the at least two related reservoir traps.

8. The method of claim 7, wherein identifying the at least two related reservoir traps is based at least in part on identifying a common structural spill point.

9. The method of claim 1, further comprising:
generating a basin model associated with the reservoir that includes an indicator of the effective trap size associated with the reservoir; and
generating a visualization of the basin model that includes a visualization of the reservoir and the indicator of the effective trap size of the reservoir for output on a display.

10. The method of claim 1, further comprising:
determining a chance of success associated with the reservoir based at least in part on the determined effective trap size.

11. A system comprising:
at least one processor;
program code configured to be executed by the at least one processor to cause the at least one processor to receive geological data associated with a reservoir, identify structural spill points for the reservoir based at least in part on the geological data, identify at least one reservoir trap for the reservoir based at least in part on the structural spill points, and determine an effective trap size associated with the reservoir based at least in part on the at least one reservoir traps and the structural spill points.

12. The system of claim 11, wherein the program code is further configured to cause the processor to determine an economic value of the reservoir based at least in part on the determined effective trap size.

13. The system of claim 12, wherein the program code is further configured to cause the processor to rank the reservoir relative to a plurality of other reservoirs based at least in part on the determined economic value.

14. The system of claim 11, wherein the program code is configured to determine the effective trap size associated with the reservoir by:
merging at least two reservoir traps based at least in part on at least a portion of the identified structural spill points; and
determining an effective trap size for the at least two merged reservoir traps,
wherein the effective trap size associated with the reservoir is based at least in part on the effective trap size for the at least two merged reservoir traps.

15. The system of claim 11, wherein the program code is configured to determine the effective trap size associated with the reservoir by:
determining a contact area between water and hydrocarbon based compounds in at least a portion of the identified reservoir traps from the geological data;
determining a seal associated with the reservoir from the geological data,
wherein the effective trap size is based at least in part on the contact area in each of the at least a portion of the identified reservoir traps, the seal associated with the reservoir, and at least a portion of the identified structural spill points.

16. The system of claim 11, wherein the program code is further configured to cause the processor to determine a depth for a first structural spill point among the identified structural spill points, wherein the effective trap size is determined based at least in part on the depth for the first structural spill point.

17. The system of claim 11, wherein the program code is configured to determine the effective trap size associated with the reservoir by:
identifying at least two related reservoir traps from among the identified reservoir traps;
identifying an overall spill point for the at least two related reservoir traps based at least in part on a depth associated with at least one identified structural spill point corresponding to at least one of the at least two related reservoir traps; and
determining an effective trap size for the at least two related reservoir traps based at least in part on the depth of the identified overall spill point,
wherein the effective trap size associated with the reservoir is based at least in part on the effective trap size for the at least two related reservoir traps.

18. The system of claim 17, wherein the at least two related reservoir traps are identified based at least in part on identifying a common structural spill point.

19. The system of claim 11, wherein the program code is further configured to cause the processor to determine a chance of success associated with the reservoir based at least in part on the effective trap size.

20. A computer program product, comprising:
a computer readable medium; and
program code stored on the computer readable medium and configured upon execution by at least one processor to cause the at least one processor to receive geological data associated with a reservoir, identify structural spill points for the reservoir based at least in part on the geological data, identify at least one reservoir trap for the reservoir based at least in part on the structural spill points, and determine an effective trap size associated with the reservoir based at least in part on the at least one reservoir traps and the structural spill points.
